(19) United States
(12) Patent Application Publication
(10) Pub. No.: US 2010/0211948 A1
(43) Pub. Date: Aug. 19, 2010

(54) METHOD AND SYSTEM FOR ALLOCATING A RESOURCE TO AN EXECUTION ENTITY

(75) Inventors: Binu Jose Philip, Karnataka (IN); Sudheer Abdul Salam, Sunnyvale, CA (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/371,790

(22) Filed: Feb. 16, 2009

(51) Int. Cl. G06F 9/46

(52) U.S. Cl. 718/100

(57) ABSTRACT

A method for allocating a resource to a requesting execution entity may include deriving at least one independently accessible resource head from the global resource, assigning the at least one resource head to the execution entity, and allocating resources from the assigned resource head to the execution entity.

### BACKGROUND

Mutual exclusion algorithms may be used in concurrent programming to protect global resources from simultaneous access by multiple threads of execution. Examples of such resources may include memory, bandwidth and time-slot. A mutual exclusion object (mutex or lock) may negotiate mutual exclusion among threads.

Several factors may affect the use of locks for synchronization:
Overhead: Additional resources, such as memory space allocated for locks, CPU time to initialize and destroy locks, and time for acquiring or releasing locks, may be necessary when implementing locks.
Contention: If one or more processes or threads attempt to acquire a lock held by another process or thread, contention may occur. This contention may reduce performance and increase service times.
Deadlock: If two tasks are waiting on locks, each holding a lock the other is waiting for, deadlock may occur.

Granularity is a measure of the amount of resource a mutex or lock is protecting. Generally, a coarse granularity (a small number of locks, each protecting a large amount of resource) may reduce overhead but increase contention. Conversely, a fine granularity (a larger number of locks, each protecting a sufficiently small amount of resource) may increase overhead but reduce contention.

Operating systems that support multi-threading may provide a feature by which threads of execution can store and retrieve data specific to the executing thread. This facility may be referred to as thread specific data (TSD). There may be multiple such data stores created for each thread. Each chunk of data stored may be identified by a key which is unique to that data store. The key value for a TSD may be decided by the entity which inserts the TSD entry.

### SUMMARY

A method for allocating a resource to an execution entity may include, in response to a request for a global resource by an execution entity executing within an instance of an operating system provided by one or more computing machines, (i) deriving at least one independently accessible resource head from the global resource, (ii) assigning the at least one resource head to the execution entity, and (iii) allocating resources from the assigned resource head to the execution entity.

The method may further include determining whether a number of existing resource heads is greater than or equal to a predetermined limit, and wherein the at least one resource head is derived if the number of existing resource heads is less than the predetermined limit.

The method may further include, in response to a request for the global resource by another execution entity, assigning the at least one resource head to the another execution entity if a number of existing resource heads is greater than or equal to a predetermined limit.

The method may further include determining whether resources owned by the assigned resource head satisfy the request for the global resource, and populating the assigned resource head with resources from the global resource if the resources owned by the assigned resource head cannot satisfy the request for the global resource.

A system for allocating a resource to an execution entity executing within an instance of an operating system may include one or more computers configured to, at run time, (i) split a global resource into at least one independently accessible local resource handle in response to a demand for the global resource by an execution entity, the at least one local resource handle owning a portion of the split global resource, (ii) associate the at least one local resource handle with the execution entity, and (iii) grant the resource owned by the associated local resource handle to the execution entity.

A computer-readable storage medium may include information stored thereon for directing one or more computers to, in response to a request for a global resource by an execution entity, (i) derive at least one independently accessible resource head from the global resource, (ii) assign the at least one resource head to the execution entity, and (iii) allocate resources from the assigned resource head to the execution entity.

While example embodiments in accordance with the invention are illustrated and disclosed, such disclosure should not be construed to limit the invention. It is anticipated that various modifications and alternative designs may be made without departing from the scope of the invention.

### BRIEF DESCRIPTION OF THE DRAWINGS

FIG. 1A is a flow chart illustrating a portion of an example algorithm for acquiring a resource.

FIG. 1B is a flow chart illustrating another portion of the example algorithm for acquiring a resource.

FIG. 1C is a flow chart illustrating yet another portion of the example algorithm for acquiring a resource.

FIG. 2 is a flow chart illustrating a portion of the example algorithm of FIG. 1C.

FIG. 3 is a flow chart illustrating an example algorithm for releasing the resource acquired in FIGS. 1A-1C.

### DETAILED DESCRIPTION

In certain multi-processing environments, a global resource, such as memory, bandwith, time-slot, etc., may be protected with, for example, a single mutex or binary semaphore. Contention for the resource, however, may be substantial under moderate to heavy load conditions. The global resource may also be split, at design time or system boot, into several access heads based on average expected load conditions. Each access head may be protected by its own mutex or lock. A round-robin policy (or other suitable policy) may then be used to handle resource requests. Contention for the resource, however, may be substantial under load conditions greater than expected.

In contrast, an execution entity (e.g., thread or process, or set of threads or processes, etc.) requesting a resource may be assigned its own resource head/handle (e.g., a location to store and access a resource along with the amount of resource available at that location, etc.) derived from the resource at the time of request. These resource heads may each have an associated mutex. New threads or processes requesting the resource may be assigned new resource heads until, for example, a pre-configured overhead or contention limit is reached. After the limit is reached, existing resource heads may be reused.

If, for example, a thread requests a resource via a call to a function/algorithm that may allocate the resource (examples of which are discussed below), it may be checked for a TSD entry for a key corresponding to the function/algorithm. If a TSD entry for the key is present, a mutex inside the TSD may be acquired (if available) and the resource allocated from the resource head in the TSD. Otherwise, a TSD entry may be created and (i) populated with a new resource head and corresponding mutex if the number of resource heads is less than a configured limit or (ii) populated with an existing resource head and corresponding mutex if the number of resource heads is equal to or greater than the configured limit. This TSD, resource head and mutex association may be valid for the lifetime of the thread.

The structure of a TSD entry (in C notation) may be as follows

```
struct scale_mutex_head {
    resource_t *r;
    mutex_t m;
    int size;
}
```

where “*r” is the resource head, “m” is the mutex, and “size” is the unit amount of the resource which is allocated to the resource head “*r.” Of course, other fields, such as the number of execution entities using this TSD entry, the amount of resource currently in use, etc., may be included.

Consider, for example, 100 units of bandwidth to be allocated among n parallel executing threads. To constrain the maximum number of resource heads that may be dynamically derived in response to thread (or process) requests, (i) an arbitrary limit (e.g., 12) may be used or (ii) a minimum resource size per resource head (e.g., 10 units per resource head) may be used. Of course, other constraint strategies may also be used. In this example, the first 12 threads requesting bandwidth will each be assigned a unique resource head if constraint (i) is used. Alternatively, the first 10 threads requesting bandwidth will each be assigned a unique resource head if constraint (ii) is used.

Assuming constraint (i) is used, contention should be minimal as long as the number of parallel executing threads is 12 or less. A 13^{th} thread (and subsequent threads) requesting bandwidth will have an existing resource head assigned to it. The 13^{th} thread waits until the thread holding the resource associated with its resource head releases the resource.

Assuming constraint (ii) is used, contention should be minimal as long as the number of parallel executing threads is 10 or less. An 11^{th} thread (and subsequent threads) requesting bandwidth will have an existing resource head assigned to it. The 11^{th} thread waits until the thread holding the resource associated with its resource head releases the resource.

If a request from a thread or process cannot be satisfied with the resource quota available to the resource head stored in the TSD, a global mutex may be acquired and the resource head re-populated. For example, if a thread requests 10 units of resource from the thread's resource head and only 5 units of resource are available, the thread may acquire the global mutex and merge 5 units of resource from the global resource pool with the resource head's local resource pool. If the global resource pool is insufficient, existing resource heads may be bled sequentially and their resources merged with the global pool until the request can be satisfied. For example, the thread may acquire the mutexes of 5 other resource heads, merge 1 unit of resource from each of the resource heads with the global resource pool, acquire the global mutex as described above, and merge 5 units of resource from the global resource pool with the resource head's local resource pool.

If a thread (or process), after returning allocated resources to its resource head, determines that the resource head now has more resources than its configured limit, the thread may merge that portion of the resource over the configured limit with the global resource pool. For example, a resource head may have a 12 unit limit. If, after returning resources allocated to it, a thread determines that the resource head now has 14 units of resource, the thread may acquire the global mutex and merge 2 units of resource from its resource head's local resource pool with the global resource pool.

### Acquire Resources Example Algorithm

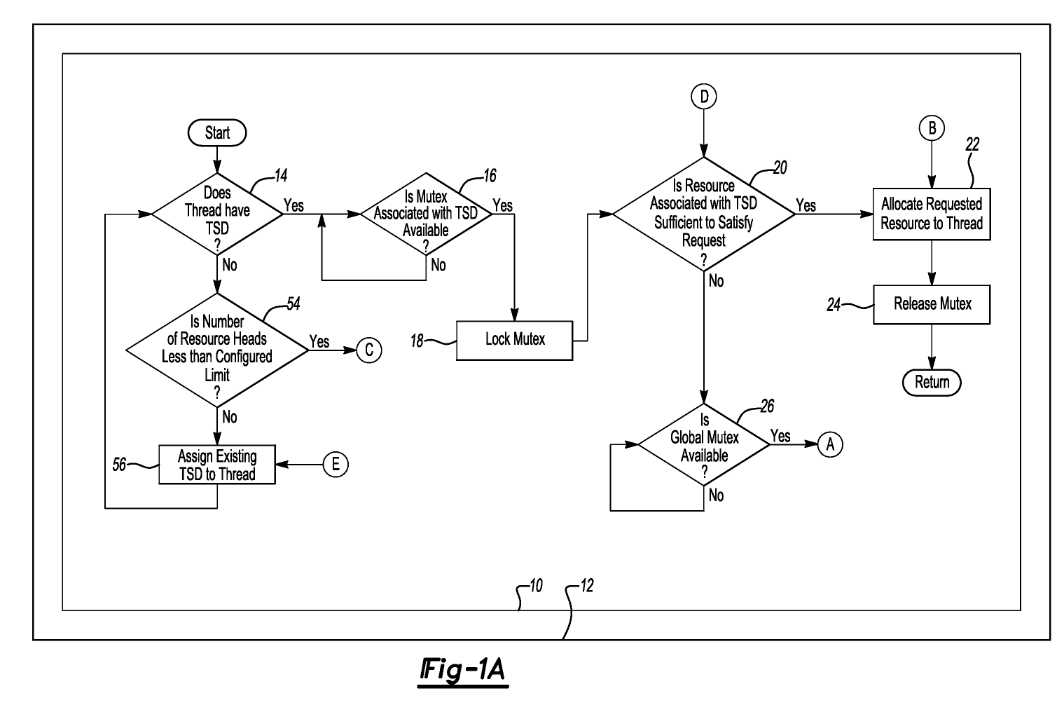

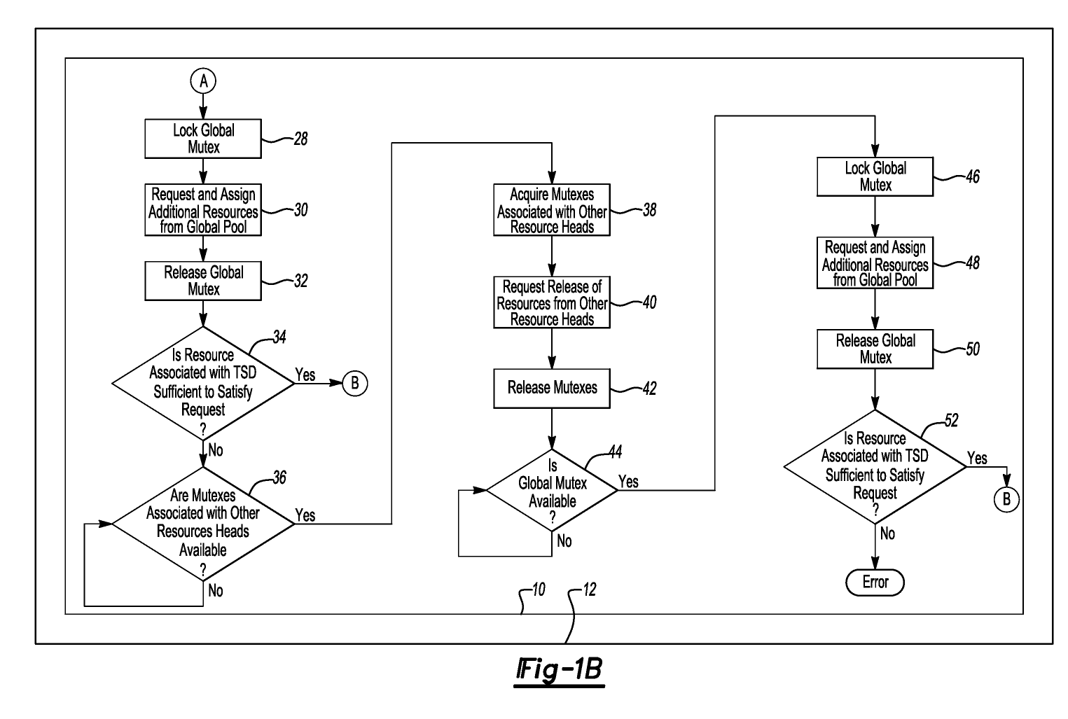

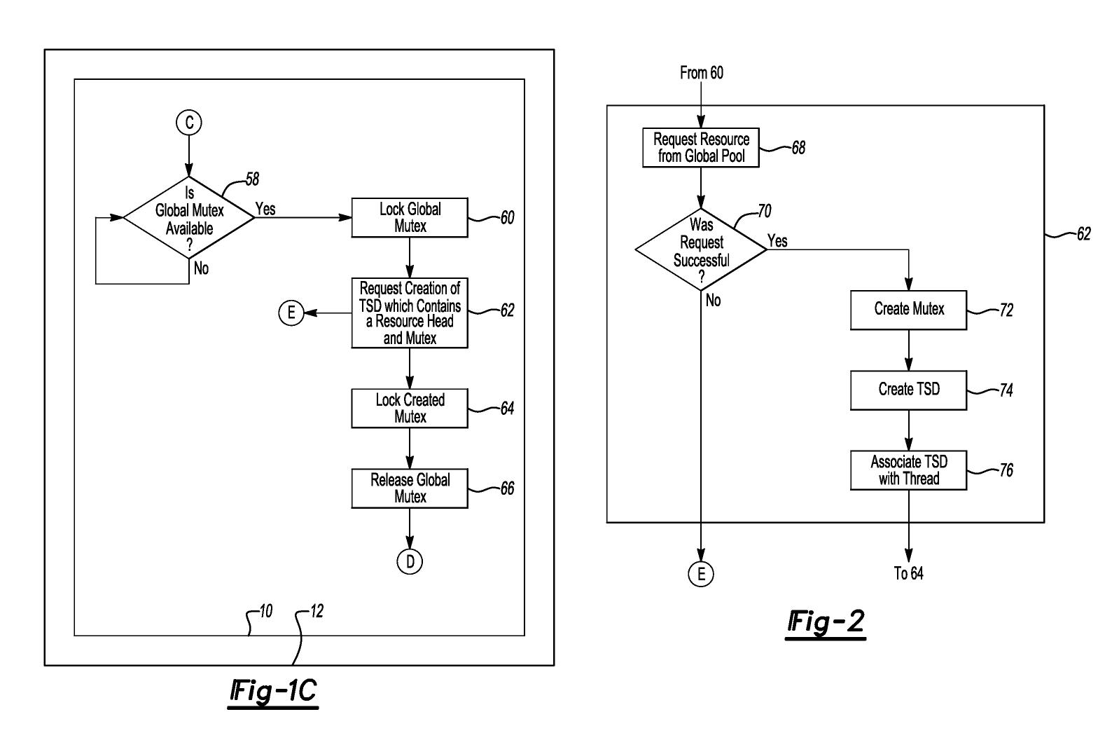

Referring now to FIGS. 1A, 1B and 1C, within an instance of an operating system 10 of one or more computers 12, a thread (or process) requesting a resource is checked to determine if it has a TSD as indicated at 14. If yes, it is determined whether a mutex associated with the TSD is available as indicated at 16. If no, the thread waits until the mutex becomes available. If yes, the mutex is locked as indicated at 18.

As indicated at 20, it is determined whether the resource pool associated with the TSD is sufficient to satisfy the request. If yes, the resource is allocated to the thread as indicated at 22. As indicated at 24, the mutex is released. If no, it is determined whether the global mutex is available as indicated at 26. If no, the thread waits until the global mutex becomes available. If yes, the global mutex is locked as indicated at 28. As indicated at 30, additional resources are requested from the global pool and assigned to the resource pool associated with the TSD. As indicated at 32, the global mutex is released.

As indicated at 34, it is determined whether the resource pool associated with the TSD is sufficient to satisfy the request. If yes, the thread proceeds to 22. If no, it is determined whether some/all mutexes associated with other resource heads are available as indicated at 36. If no, the thread waits until the mutexes associated with other resource heads are available. If yes, the mutexes associated with other resource heads are acquired as indicated at 38. As indicated at 40, the release of resources associated with other resource heads is requested. As indicated at 42, the mutexes acquired at 38 are released.

As indicated at 44, it is determined whether the global mutex is available. If no, the thread waits until the global mutex is available. If yes, the global mutex is locked as indicated at 46. As indicated at 48, additional resources are requested from the global pool and assigned to the resource pool associated with the TSD. As indicated at 50, the global mutex is released.

As indicated at 52, it is determined whether the resource pool associated with the TSD is sufficient to satisfy the request. If no, an error may be reported. If yes, the thread proceeds to 22.

Returning again to 14, if no, it is determined whether the number of resource heads is less than the configured limit. If no, an existing TSD is assigned to the thread as indicated at 56. The thread then proceeds to 14. If yes, it is determined whether the global mutex is available as indicated at 58. If no, the thread waits until the global mutex is available. If yes, the global mutex is locked as indicated at 60. As indicated at 62, creation of a TSD which contains a resource and mutex is requested. As indicated at 64, the created mutex is locked. (As discussed below, the thread may alternatively proceed to 56.) As indicated at 66, the global mutex is released. The thread then proceeds to 20.

Referring now to FIG. 2, resources are requested from the global resource pool as indicated at 68. As indicated at 70, it is determined whether the request was successful. If no, the thread proceeds to 56. If yes, a mutex is created as indicated at 72. As indicated at 74, a TSD is created. As indicated at 76, the created TSD is associated/assigned with the thread. The thread then proceeds to 64.

### Return Resources Example Algorithm

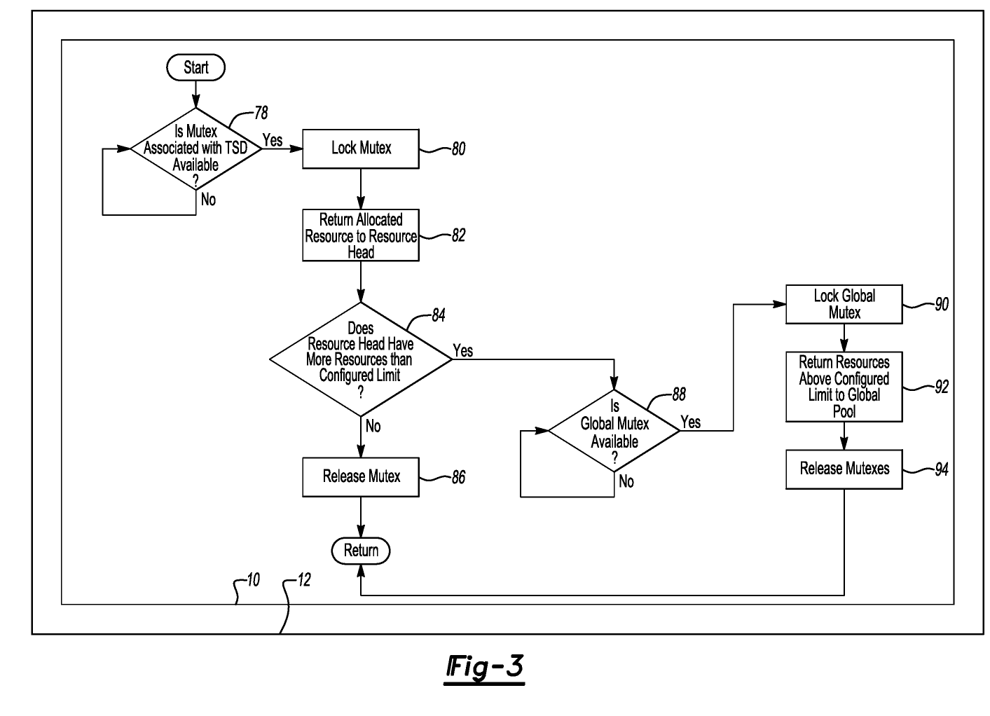

Referring now to FIG. 3, it is determined whether the mutex associated with the thread's TSD is available as indicated at 78. If no, the thread continues to wait until the mutex associated with the thread's TSD is available. If yes, the mutex is locked as indicated at 80. As indicated at 82, the allocated resource is returned to the resource head associated with the TSD.

As indicated at 84, it is determined whether the resource head has more resources than a configured limit. If no, the mutex is released as indicated at 86. If yes, it is determined whether the global mutex is available as indicated at 88. If no, the thread waits until the global mutex is available. If yes, the global mutex is locked as indicated at 90. As indicated at 92, the resources above the configured limit are returned to the global pool. As indicated at 94, the mutexes are released.

As apparent to those of ordinary skill, the algorithms disclosed herein may be deliverable to a processing device in many forms including, but not limited to, (i) information permanently stored on non-writable storage media such as ROM devices and (ii) information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), state machines, controllers or other hardware components or devices, or a combination of hardware, software and firmware components.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for allocating a resource to an execution entity comprising:
in response to a request for a global resource by an execution entity executing within an instance of an operating system provided by one or more computing machines, (i) deriving at least one independently accessible resource head from the global resource, (ii) assigning the at least one resource head to the execution entity, and (iii) allocating resources from the assigned resource head to the execution entity.

2. The method of claim 1 further comprising determining whether a number of existing resource heads is greater than or equal to a predetermined limit.

3. The method of claim 2 wherein the at least one resource head is derived if the number of existing resource heads is less than the predetermined limit.

4. The method of claim 1 further comprising, in response to a request for the global resource by another execution entity, assigning the at least one resource head to the another execution entity if a number of existing resource heads is greater than or equal to a predetermined limit.

5. The method of claim 1 further comprising determining whether resources owned by the assigned resource head satisfy the request for the global resource.

6. The method of claim 5 further comprising populating the assigned resource head with resources from the global resource if the resources owned by the assigned resource head cannot satisfy the request for the global resource.

7. The method of claim 1 wherein the assigning of the at least one resource head to the execution entity is valid for the lifetime of the execution entity.

8. A system for allocating a resource to an execution entity executing within an instance of an operating system, the system comprising:
one or more computers configured to, at run time,
split a global resource into at least one independently accessible local resource handle in response to a demand for the global resource by an execution entity, the at least one local resource handle owning a portion of the split global resource,
associate the at least one local resource handle with the execution entity, and
grant the resource owned by the associated local resource handle to the execution entity.

9. The system of claim 8 wherein the one or more computers are further configured to determine whether a number of existing local resource handles is greater than or equal to a predetermined limit.

10. The system of claim 9 wherein the global resource is split into the at least one independently accessible local resource handle if the number of existing local resource handles is less than the predetermined limit.

11. The system of claim 8 wherein the one or more computers are further configured to, in response to a demand for the global resource by another execution entity, associate the at least one local resource handle with the another execution entity if a number of existing local resource handles is greater than or equal to a predetermined limit.

12. The system of claim 8 wherein the one or more computers are further configured to determine whether the resource owned by the associated local resource handle satisfies the demand for the global resource.

13. The system of claim 12 wherein the one or more computers are further configured to populate the associated local resource handle with resources from the global resource if the resource owned by the associated local resource handle cannot satisfy the demand for the global resource.

14. The system of claim 8 wherein the association of the at least one local resource handle with the execution entity is valid for the lifetime of the execution entity.

15. A computer-readable storage medium having information stored thereon for directing one or more computers to, in response to a request for a global resource by an execution entity, (i) derive at least one independently accessible resource head from the global resource, (ii) assign that at least one resource head to the execution entity, and (iii) allocate resources from the assigned resource head to the execution entity.

16. The storage medium of claim 15 having information stored thereon for further directing the one or more computers to determine whether a number of existing resource heads is greater than or equal to a predetermined limit.

17. The storage medium of claim 16 having information stored thereon for further directing the one or more computers to derive the at least one resource head if the number of existing resource heads is less than the predetermined limit.

18. The storage medium of claim 16 having information stored thereon for further directing the one or more computers to, in response to a request for the global resource by another execution entity, assign the at least one resource head to the another execution entity if the number of existing resource heads is greater than or equal to the predetermined limit.

19. The storage medium of claim 15 having information stored thereon for further directing the one or more computers to determine whether resources owned by the assigned resource head satisfy the request for the global resource.

20. The storage medium of claim 19 having information stored thereon for further directing the one or more computers to populate the assigned resource head with resources from the global resource if the resources owned by the assigned resource head cannot satisfy the request for the global resource.
